(19) United States
(12) Patent Application Publication
(10) Pub. No.: US 2025/0113140 A1
(43) Pub. Date: Apr. 3, 2025

(54) MOTION-DRIVEN AUDIO FOR MECHANICAL SYSTEMS

(71) Applicant: DISNEY ENTERPRISES, INC., Burbank, CA (US)

(72) Inventors: Michael Anthony Hopkins, Pasadena, CA (US); Steven Pickles, Gainesville, FL (US); Joel Peavy, Poway, CA (US); Jared Edward Bishop, Ventura, CA (US); Moritz Niklaus Bächer, Zurich (CH); Georg Wiedebach, Glendale, CA (US); Ruben Jelle Grandia, Opfikon (CH); Lars Espen Knoop, Birmensdorf (CH)

(21) Appl. No.: 18/903,269

(22) Filed: Oct. 1, 2024

Related U.S. Application Data
(60) Provisional application No. 63/542,223, filed on Oct. 3, 2023.

(51) Int. Cl. H04R 1/22; B25J 11/00; B25J 19/02; G06F 16/63

(52) U.S. Cl. CPC H04R 1/22; B25J 11/003; G06F 16/63; B25J 19/02

(57) ABSTRACT

A computer implemented method for generating a motion-driven sound effect includes: determining, via a processor, a mechanical characteristic of a mechanical system; modifying, via the processor, an audio clip based on the mechanical characteristic; and outputting, via the processor, the audio clip based on the mechanical characteristic.

### CROSS REFERENCE TO RELATED APPLICATION

This present application claims priority to U.S. Provisional application No. 63/542,223 entitled “Motion-Driven Sound Effects for Robotic Characters,” filed on Oct. 3, 2023, which is hereby incorporated by reference herein in its entirety.

### BACKGROUND

Film and television portrayals of robotic characters are often accompanied by physically-inspired sound effects that emulate whining motors, whirring gears, and other noises related to electro-mechanical, hydraulic, or steam-powered systems. These sound effects are typically added in post-production, allowing artists to author soundtracks that match the timing, speed, and physical characteristics of a robot's motion in each scene.

Similar approaches may be used to add artificial sound effects that accompany a physical robot, enhancing or modifying the mechanical sounds accompanying the robot's movements in an environment. In such cases, the use of a predefined soundtrack or accompanying set of sound clips is typically only valid so long as the robot's motion is also predefined, i.e., a trajectory that is known ahead of time. When a robotic character is driven by an on-line planner, AI, or human operator, this is typically not the case, as the robot's movements will vary in response to any number of factors related to its interaction with the environment, humans, or other robots. In general, interactive robots adapt their motion on the fly to effectively locomote, manipulate, observe, and communicate in uncertain environments. As a result, predefined sound tracks cannot accurately match the timing, speed, etc. of the generated motions.

Furthermore, it may be desirable for the robotic character to play audio or sound effects in response to the robotic character's interaction with external factors. For example, it may be desirable for a robotic character to play an appropriate sound effect when it comes in contact with an obstacle. As external factors are unpredictable, predefined sound tracks cannot accurately represent the expected the sound effect upon the interaction with an external factor.

For applications involving human-robot interaction, especially in the entertainment field, the sounds produced by a robotic character can have a significant impact on how humans perceive and interact with that character.

### BRIEF SUMMARY

In one embodiment, a computer implemented method for generating a motion-driven sound effect includes: determining, via a processor, a mechanical characteristic of a mechanical system; modifying, via the processor, an audio clip based on the mechanical characteristic; and outputting, via the processor, the audio clip based on the mechanical characteristic.

Optionally, in some embodiments, the mechanical characteristic includes at least one of a position, velocity, acceleration, or torque of a component of the mechanical system.

Optionally, in some embodiments, the velocity, acceleration, or torque of the component is caused by a force applied to the component external to the mechanical system.

Optionally, in some embodiments, the mechanical characteristic includes at least one of an ambient temperature or weather condition of the mechanical system.

Optionally, in some embodiments, determining the mechanical characteristic of the mechanical system includes: measuring a physical parameter of the mechanical system with a physical parameter sensor; and determining the mechanical characteristic based on the physical parameter.

Optionally, in some embodiments, determining the mechanical characteristic of the mechanical system includes estimating a velocity of the mechanical system based on a change in position of an actuator of the mechanical system.

Optionally, in some embodiments, modifying the audio clip based on the mechanical characteristic includes selecting the audio clip based on the mechanical characteristic.

Optionally, in some embodiments, selecting an audio clip includes selecting an audio clip based on a physical characteristic of the mechanical system; the physical characteristic includes at least one of a material of the mechanical system, a construction of the mechanical system, or a purpose of the mechanical system.

Optionally, in some embodiments, modifying the audio clip based on the mechanical characteristic includes modifying the frequency and amplitude of the audio clip to replicate a physical sound associated with a velocity and acceleration of a component of the mechanical system.

Optionally, in some embodiments, modifying the audio clip based on the mechanical characteristic includes modifying the frequency and amplitude of the audio clip to replicate a physical sound associated with an external force or torque applied to a component of the mechanical system.

Optionally, in some embodiments, modifying the audio clip based on the mechanical characteristic includes modifying a frequency of the audio clip within a minimum frequency threshold and a maximum frequency threshold.

Optionally, in some embodiments, modifying the audio clip based on the mechanical characteristic includes modifying an amplitude of the audio clip within a minimum amplitude threshold and a maximum amplitude threshold.

Optionally, in some embodiments, wherein outputting the audio clip based on the mechanical characteristic includes outputting the audio clip from a designated audio output device mounted to the mechanical system.

Optionally, in some embodiments, the designated audio output device is one of a plurality of audio output devices, wherein the designated audio output device is the audio output device located closest in proximity to the source of the mechanical characteristic.

Optionally, in some embodiments, outputting the audio clip based on the mechanical characteristic includes outputting a loop of the audio clip coinciding in real-time with the mechanical characteristic.

Optionally, in some embodiments, outputting the audio clip based on the mechanical characteristic includes outputting the audio clip upon the occurrence of a trigger condition, coinciding in real-time with the trigger condition.

In one embodiment, a mechanical system for generating motion-driven audio, includes: an audio output device; a physical parameter sensor; a local storage system; and a processor configured by instructions to perform operations includes: determining a mechanical characteristic of the mechanical system; modifying an audio clip based on the mechanical characteristic; and outputting the audio clip based on the mechanical characteristic to the audio output device.

Optionally, in some embodiments, modifying the audio clip based on the mechanical characteristic includes modifying the frequency and amplitude of the audio clip to replicate a physical sound associated with a velocity and acceleration of a component of the mechanical system.

Optionally, in some embodiments, modifying the audio clip based on the mechanical characteristic includes modifying the frequency and amplitude of the audio clip to replicate a physical sound associated with an external force or torque applied to a component of the mechanical system.

Optionally, in some embodiments, outputting the audio clip based on the mechanical characteristic includes outputting the audio clip coinciding in real-time with the mechanical characteristic.

### BRIEF DESCRIPTION OF THE SEVERAL VIEWS OF THE DRAWINGS

FIG. 1 illustrates an example of a mechanical system.

FIG. 2 illustrates an example of a computer-implemented audio engine.

FIG. 3 illustrates an example of a mechanical system as described in FIG. 1.

FIG. 4 is a flow diagram for retrieving and modifying an audio clip with the audio engine of FIG. 2.

FIG. 5 is a flow diagram for playing an audio clip with the audio engine of FIG. 2.

FIG. 6 illustrates an example flow diagram for generating motion-driven audio as described with respect to method 400 and method 500.

FIG. 7 illustrates an example block diagram of an audio engine 114 as described with respect to FIG. 2.

FIG. 8 is a block diagram of an example computer system suitable for use in the audio engine of FIG. 2.

### DETAILED DESCRIPTION

The system described herein may include a motion-driven audio engine that generates sounds (e.g., mechanical and physically inspired sounds) based on the real-time movements and other mechanical characteristics of a mechanical system. As used herein, mechanical characteristics include any physical parameter or characteristic of a mechanical system, such as a velocity, acceleration, position, movement state, location, force, torque, weight, and size of the mechanical system. Mechanical characteristics may also include characteristics applied to the mechanical system by an external source, such as a force or torque applied to the mechanical system and the ambient temperature or weather conditions around the mechanical system.

In some examples, the audio engine may be a sound effects (SFX) engine and the mechanical system may be a robotic character. The audio engine modulates one or more audio clips based on the measured or commanded mechanical characteristic of the mechanical system, including the estimated/desired position, velocity, acceleration, and/or torque of the kinetic components. The audio produced by the proposed system may be designed to sound physically plausible, e.g., reproducing the audio characteristics of a simple gearbox, or fantastical in nature, such as a cartoon inspired whirring sound. Predetermined sound tracks that may be used with certain physical movement displays are not desirable with physical robots that can move in response to environmental conditions, e.g., the soundtrack would likely have output that did not align with the actual movement of the mechanical as it went off script, responded to a unique environmental condition, or the like. Furthermore, the audio engine may generate audio in response to the ambient environment of the mechanical system, such as generating a metallic rusting sound when the mechanical system is moving in rainy conditions; such sound effects increase the immersive experience of the mechanical system compared to predetermined sound effects.

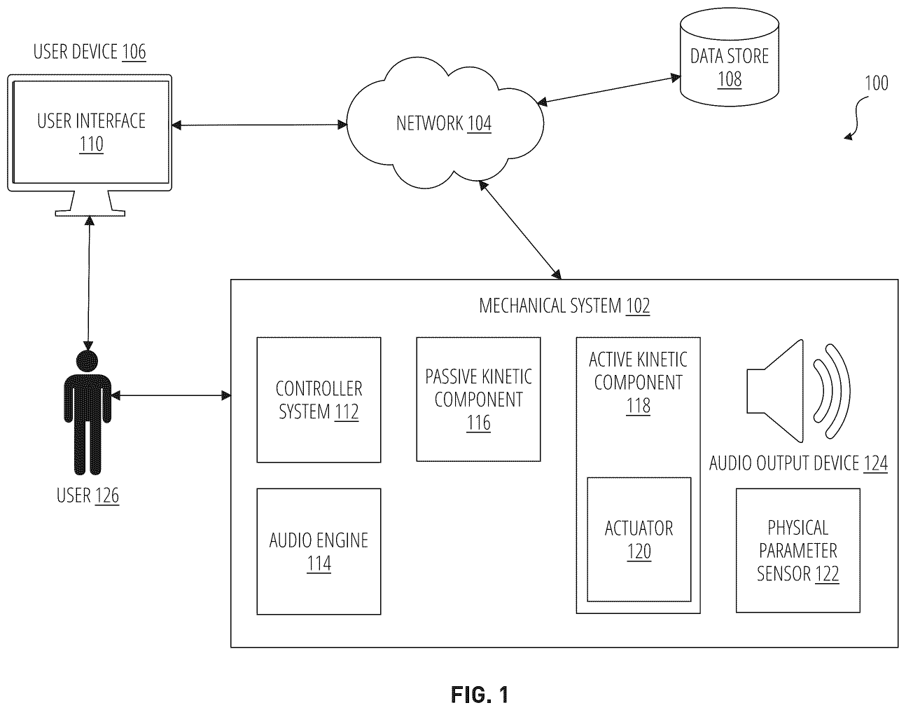

Turning now to the figures, FIG. 1 illustrates an example system 100. The system 100 provides motion-driven audio to a user 126 via an audio engine 114 of a mechanical system 102. The motion-driven audio may be configured to correspond to a mechanical characteristic of the mechanical system 102, such as a physical movement of the mechanical system. The system 100 includes a user device 106 and a data store 108 in communication with a mechanical system 102 either directly or via a network 104. In some embodiments, the mechanical system 102 includes a controller system 112, an audio engine 114, a passive kinetic component 116, an active kinetic component 118 that may include an actuator 120, an audio output device 124, and a physical parameter sensor 122.

In some examples, mechanical system 102 may be a robot or robotic character. The mechanical system 102 is accessible by a user 126 through a user interface 110 provided by the user device 106, e.g., through a software application. In some embodiments, the mechanical system 102 may be in communication with one or more user devices 106 and one or more data stores 108. In some embodiments, the mechanical system 102, the user device 106, and/or the data store 108 may be incorporated into the user device 106 and/or the mechanical system 102 as a single system rather than separate systems.

In some embodiments, a user 126 may engage with the system 100 through a user device 106. For example, the user 126 may be an operator controlling or operating the mechanical system 102, such as by controlling the movement and audio of the mechanical system 102 via the user interface 110. In some embodiments, a user 126 may engage with the system 100 by interacting with the mechanical system 102 directly. For example, the user 126 may be a theme park patron interacting with the mechanical system 102 through physical contact, such as by touching or moving the mechanical system 102.

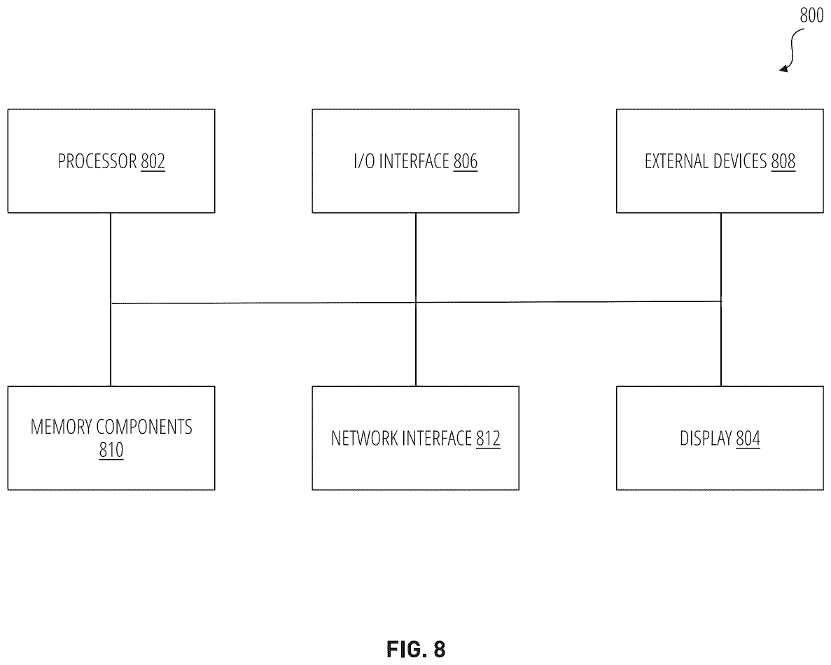

In some embodiments the mechanical system 102 includes a controller system 112. The controller system 112 may include a memory and a processor configured to control the mechanical system 102, such as the movement of mechanical components of the mechanical system 102. The controller system 112 may be a computing device as described with respect to FIG. 8, and the memory of the controller system 112 may store data and instructions which may be executed by the processor of the controller system 112.

In some examples, the controller system 112 may control the mechanical system 102 via an external input. The controller system 112 may receive an instruction input by a user 126 via the user interface 110 from the user device 106 (e.g., via the network 104) instructing a movement of the mechanical system 102, such as input via a joystick or other input device. The controller system 112 may implement the received instruction to control the movement of the mechanical system 102 based on the instruction. For example, the user 126 may direct the movement path of a robotic character by inputting instructions to the user interface 110 that are then executed by the controller system 112.

In other examples, the controller system 112 may control the mechanical system 102 via instructions stored internally in the controller system 112 (e.g., stored in memory). The controller system 112 may implement internally stored instructions directing a movement for the mechanical system 102. For example, the controller system 112 may store instructions for a predetermined movement path of a robotic character; the controller system 112 may execute the instructions to cause the robotic character to move along the predetermined path.

In other examples, the controller system 112 may include an artificial intelligence model that the controller system 112 may leverage to generate an instruction for the mechanical system 102. For example, the artificial intelligence model may be a machine learned model trained to generate instructions coordinating unassisted movement of a robotic character. The controller system 112 may execute the generated instructions to control the movement of the robotic character.

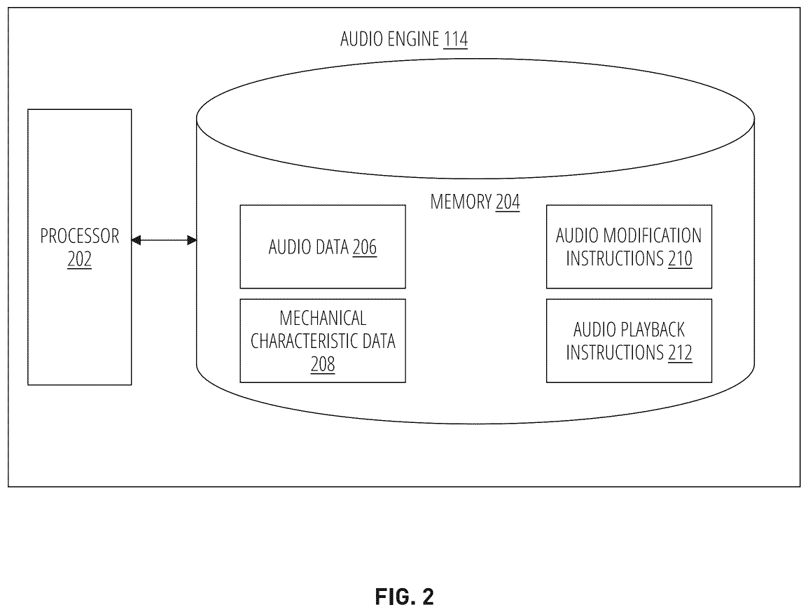

In some embodiments, the mechanical system 102 includes an audio engine 114. The audio engine 114 may include a memory 204 and a processor 202 (or may be other coupled to similar components) configured to retrieve, modify, and play audio related to the mechanical system 102. In some examples, the audio engine 114 may be configured to retrieve, modify, and play audio based on a mechanical characteristic of the mechanical system 102, such as a movement or change of a mechanical component of the mechanical system 102. In some examples, the audio engine 114 may be a sound effects (SFX) engine. The audio engine 114 may be a computing device as described with respect to FIG. 8, and the memory 204 may store data and instructions which may be executed by the processor 202. The audio engine 114 is described in more detail with respect to FIG. 2.

In some embodiments, the mechanical system 102 includes a passive kinetic component 116. As used herein, a kinetic component represents a mechanical component of the mechanical system 102 configured for physical movement. For example, a kinetic component may include joints, pivot points, axles, wheels, etc. As used herein, a passive kinetic component 116 represents a kinetic component without an actuator internal to the mechanical system 102 powering the movement of the kinetic component. For example, a passive kinetic component 116 may include a lever or switch of the mechanical system 102 that is not powered by a motor, but that can be moved by a user 126.

In some embodiments, the mechanical system 102 includes an active kinetic component 118. As used herein, an active kinetic component 118 represents a kinetic component of the mechanical system 102 with an actuator internal to the mechanical system 102 powering the movement of the kinetic component (e.g., a directly powered component). The active kinetic component 118 may include an actuator 120 that drives the movement of the active kinetic component 118. For example, an active kinetic component 118 may include an arm of a robotic character with an internal servo motor driving the movement of the arm.

In some embodiments, the mechanical system 102 includes a physical parameter sensor 122. The physical parameter sensor 122 may detect a mechanical characteristic of the mechanical system 102, such as a physical parameter of the passive kinetic component 116 or active kinetic component 118. The physical parameter sensor 122 may include one or more sensors configured to measure the position, movement, and/or force characteristics of the kinetic component, such as a speedometer, accelerometer, compass, gyroscopic sensor, global positioning sensor (GPS), force sensor, torque sensor, and the like. For example, the physical parameter sensor 122 may include a sensor configured to measure the position, velocity, and acceleration of an arm of a robotic character or the torque of an arm joint of the robotic character. The physical parameter sensor 122 may also receive data from the controller system 112 or the actuator 120 to estimate the movement characteristics of the kinetic component. For example, the physical parameter sensor 122 may retrieve movement instructions for a kinetic component from the controller system 112 to estimate the position, velocity, and acceleration of the kinetic component. The physical parameter sensor 122 may also retrieve data from sensors or systems external to the mechanical system 102 to detect a physical parameter of the kinetic component. For example, the physical parameter sensor 122 may retrieve weather data of the ambient environment of the mechanical system 102 to estimate the ambient temperature of the mechanical system 102.

In some embodiments, the mechanical system 102 include an audio output device 124 (e.g., a speaker). The audio output device 124 may be configured to output audio as directed by the audio engine 114. The audio output device 124 may be positioned within or near a kinetic component. In such examples, the audio output device 124 may be configured to output audio based on a mechanical characteristic of the kinetic component. For example, an audio output device 124 positioned in the arm joint of a robotic character may be configured to output audio reflecting the movement of the arm joint.

In some examples, the user device 106 may be a device utilized by a user 126, such as a mobile device or computer. The user device 106 may communicate with the mechanical system 102 via network 104. The user device 106 and network 104 are discussed in more detail with respect to FIG. 8. In some examples, the mechanical system 102 or a component within the mechanical system 102 is executed on the user device 106. In such examples, communication between the mechanical system 102 and the user device 106 may not be via network 104.

In some embodiments, the mechanical system 102 may be in communication with a data store 108. The data store 108 may include memory storage (e.g., in a server) for storing data, such as audio data 206, mechanical characteristic data 208, or other such data. For example, data store 108 may be a server hosting data of audio clips representing different sound effects. The data store 108 may be implemented as one storage device (e.g., physical device) or distributed across various storage devices.

The components of FIG. 1 are exemplary only. In various examples, the mechanical system 102 may communicate with and/or include additional components and/or functionality not shown in FIG. 1. Although not shown in FIG. 1, the mechanical system 102 may also be in communication with other systems or components. For example, the mechanical system 102 may communicate with other mechanical systems or platforms.

FIG. 2 illustrates an example audio engine 114, as described with respect to FIG. 1. The audio engine 114 provides motion-driven audio to a user 126 based on a mechanical characteristic of the mechanical system 102. In some embodiments, the audio engine 114 includes a memory 204 and a processor 202. The memory 204 may include or access various types of data or instructions used by the audio engine 114. Such data and instructions may include audio data 206, mechanical characteristic data 208, audio modification instructions 210, and audio playback instructions 212, in various examples. Such data and instructions may be stored on and/or executed by a computing device as described with respect to FIG. 8. The processor 202 may be in communication with the memory 204 and may be configured to execute the instructions.

In some embodiments, the audio engine 114 includes mechanical characteristic data 208 stored e.g., on the memory 204. The mechanical characteristic data 208 may store data related to a mechanical characteristic of the mechanical system 102. For example, mechanical characteristic data 208 may include a physical parameter and sensor data of the mechanical system. The physical parameter may include a movement characteristic of the mechanical system 102, such as velocity, acceleration, and/or positional data of a component of the mechanical system 102. For example, the movement characteristic of a robotic character may include the angular acceleration and angular velocity of an arm component of the robotic character pivoting in a shoulder joint component of the robotic character. The physical parameter may include a force characteristic of the mechanical system 102, such as a force and/or torque applied to and/or applied by a component of the mechanical system 102. For example, the physical parameter may include a torque applied to a robotic arm component of a robotic character. The sensor data may include data collected from sensors internal to the mechanical system 102 and/or received from sensors or data sources outside of the mechanical system 102 related to the mechanical system 102, such as temperature data, light data, weather data, data regarding obstacles in the movement path of the mechanical system 102, and the like. For example, sensor data may include data indicating that the ambient environment of a robotic character is experiencing cold temperatures or rainfall.

The audio engine 114 may receive the mechanical characteristic data 208 from the actuator 120, physical parameter sensor 122, data store 108, or user device 106 and store the mechanical characteristic data 208 in memory 204. The audio engine 114 may retrieve the mechanical characteristic data 208 from the actuator 120 of an active kinetic component 118. The audio engine 114 may include an encoder or other element configured to measure and/or estimate a mechanical characteristic of the active kinetic component 118 based on data of the actuator 120. For example, the audio engine 114 encoder may measure the angular velocity of the active kinetic component 118 based on the rotations per minute of the actuator 120.

The audio engine 114 may receive the mechanical characteristic data 208 from the physical parameter sensor 122. For example, the audio engine 114 may receive velocity and acceleration measurements from a Hall effect sensor measuring a movement character of a passive kinetic component 116. The audio engine 114 may receive the mechanical characteristic data 208 from the data store 108. For example, the audio engine 114 may receive weather and temperature data from a data store 108 such as a weather service server. The audio engine 114 may receive the mechanical characteristic data 208 from the user device 106. For example, where the user 126 inputs movement instructions for the mechanical system 102, the audio engine 114 may estimate a movement characteristic of the mechanical system 102 based on the movement instructions. In some examples, the encoder of the audio engine 114 may encode the mechanical characteristic data 208 to a data format accessible by the audio engine 114. For example, the encoder may encode position, velocity, and acceleration measurements detected by the physical parameter sensor 122 to a digital data format.

In some embodiments, the audio engine 114 includes audio data 206 stored e.g., on the memory 204. The audio data 206 may store data related to the motion-driven audio of the mechanical system 102. For example, the audio data 206 may include an audio clip and audio metadata. The audio clip may include a data file of audio configured for modification and playback. For example, the audio clip may be a sound effect stored in an audio format, such as M4A, FLAC, MP3, MP4, WAV, WMA, AAC, or the like. In some examples, the audio clip may be a sound effects (SFX) file that includes SFX audio. Audio metadata may include metadata of the audio clip, such as the file format, compression data, name, and content of the audio clip. The audio metadata may also include characteristics of the audio of the audio clip, such as the tempo of the audio, frequency range and amplitude range represented by the audio, the time length of the audio, etc. For example, the audio metadata of a sound effect audio clip may include the name of the sound effect, the volume and speed of the sound effect, and the duration of the sound effect.

The audio engine 114 may receive the audio data 206 from the data store 108 or the user device 106 (e.g., via the network 104) and store the audio data 206 in memory 204. In some examples, the audio engine 114 may retrieve the audio data 206 from the data store 108 based on the mechanical characteristic data 208. For example, where the mechanical characteristic data 208 of a robotic character indicates that the robotic character will be moving at a high speed, the audio engine 114 may retrieve an audio clip of a sound effect corresponding to high-speed movement from the data store 108. In another example, the audio engine 114 may receive audio data 206 from the user device 106 input or selected by the user 126 through the user interface 110. For example, an operator of a robotic character may record an audio segment with the user device 106 to be played via the mechanical system 102. The user device 106 may communicate the audio segment to the audio engine 114 (e.g., via the network 104).

In some embodiments, the audio engine 114 includes audio modification instructions 210 stored e.g., on the memory 204. The audio modification instructions 210 may, when executed by the processor 202, modify the audio data 206 based on the mechanical characteristic data 208 (e.g., as according to method 400). The audio modification instructions 210 may include instructions to modify an audio clip, such as by changing the volume, speed, duration, and the like of the audio clip. The audio modification instructions 210 may include instructions to modify the audio clip based on the mechanical characteristic data 208 such that the audio clip reflects an expected or “realistic” audio of the mechanical system 102. For example, where the mechanical system 102 is a robotic character, an audio clip representing movement audio may be modified to increase in tempo when the robotic character accelerates, and the audio clip may be modified to decrease in tempo when the robotic character decelerates, such that the playback appears to be generated by the movement of the robotic character itself as its correlates to the movement. The audio modification instructions 210 may also include instructions to modify an audio clip by mixing or combining the audio clip with an additional audio clip and/or by modifying the audio clip with audio effects. For example, where the mechanical characteristic data 208 indicates that the robotic character is moving in ambient rainfall, the audio clip may be mixed with an additional audio clip representing audio of a movement of rusting metal. In another example, where the mechanical characteristic data 208 indicates that the robotic character is moving in an environment with snowfall, the audio clip may be modified with a muffled effect to represent the dampened sound of movement through snowfall.

In some embodiments, the 114 includes audio playback instructions 212 stored e.g., on the memory 204. The audio playback instructions 212 may, when executed by the processor 202, control the playback of the audio data 206 on the audio output device 124 (e.g., as according to method 500). The audio playback instructions 212 may include instructions to determine the audio playback procedure for an audio clip. For example, the audio playback procedure may include a procedure to play the audio in a loop or a procedure to play the audio upon the occurrence of a trigger event. The audio playback instructions 212 may include instructions to determine the audio output device 124 appropriate for the playback of the audio clip. In some examples, the audio clip may be played from the audio output device 124 located near the source of the movement corresponding with the audio of the audio clip. For example, audio reflecting the movement of a shoulder joint component of a robotic character may be played from an audio output device 124 near the shoulder joint component. In other examples, the audio clip may be played from a plurality of audio output devices 124 and played at a volume based on the proximity of the audio output device 124 to the source of the movement corresponding with the audio of the audio clip. For example, audio reflecting the movement of a shoulder joint component of a robotic character may be played from multiple audio output devices 124, and the audio may be played at a louder volume from an audio output device 124 closer to the shoulder joint component and played at a quieter volume from an audio output device 124 further from the shoulder joint component. It should be noted in other instances the audio playback instructions may be stored as part of the audio modification instructions 210.

While the data and instructions, such as the audio data 206, mechanical characteristic data 208, audio modification instructions 210, and audio playback instructions 212 are shown in FIG. 2 as being stored in the memory 204, in some examples, the data and instructions may be stored at other memory resources of the mechanical system 102 and/or at locations remote from the mechanical system 102, such as various databases or data stores (e.g., the data store 108). In such examples, the memory 204 of the audio engine 114 may include instructions for accessing such data and instructions from remote locations, including, for example, the locations of the data and/or specific queries used to retrieve data for use by the audio engine 114. For example, where the audio data 206 is stored in the data store 108, memory 204 may include instructions for how to retrieve or access the data from the data store 108.

The audio engine 114 may be implemented by or at a computing device or combinations of computing resources in various embodiments. In various examples, the audio engine 114 may be implemented by one or more servers, cloud computing resources, and/or other computing devices. The audio engine 114 may, for example, be incorporated as a module within a mobile application, software application, or a website presented through a web browser (e.g., at a laptop or desktop computer), and the like. In such examples, the audio engine 114 may be implemented external to the mechanical system 102 and may communicate with the mechanical system 102 (e.g., via the network 104).

The components of FIG. 2 are exemplary only. In various examples, the audio engine 114 may communicate with and/or include additional components and/or functionality not shown in FIG. 2. Although not shown in FIG. 2, the audio engine 114 may also be in communication with other systems or components. For example, the audio engine 114 may communicate with external audio modification systems.

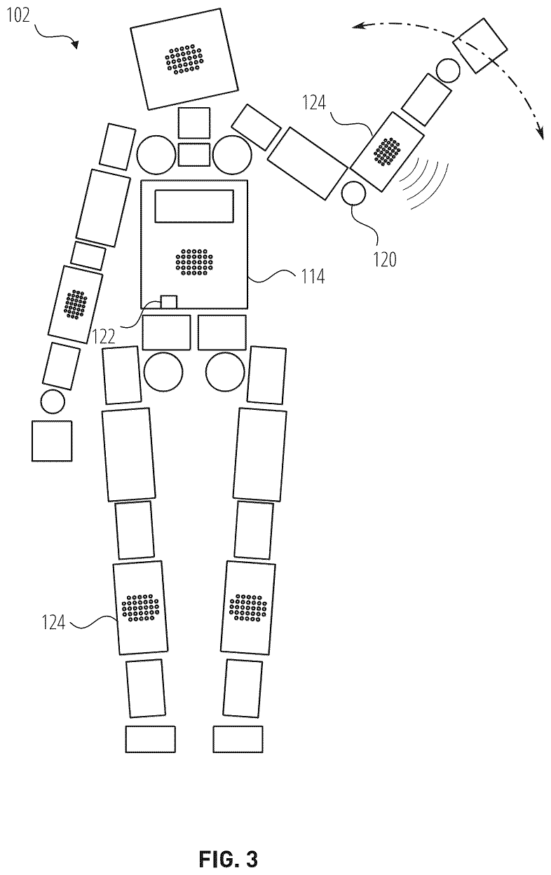

FIG. 3 illustrates an example mechanical system 102 as described with respect to FIG. 1. As described with respect to FIG. 1, the mechanical system 102 may be a robotic character, and may include an audio engine 114, actuator 120, physical parameter sensor 122, and audio output device 124. For example, as shown in FIG. 3, the actuator 120 may cause the movement of an arm component of the robotic character, and the audio output device 124 mounted in the arm component may play audio based on the movement of the arm component.

As shown in FIG. 3, a robot using the proposed sound effects engine may include speakers mounted to different parts of its assembly, for example: a speaker in the head, torso, and on limbs of a humanoid, the speakers may generate different audio content associated and collocated with specific groups of joints/actuators. It should be noted that the audio output devices 124, e.g., speakers, may be located in various positions of the robot and the position may vary depending on the robotic character.

Robotic characters using the proposed systems are not restricted to humanoids and may come in a variety of form factors, including, for example, quadrupeds and/or robotic arms. The discussion of any particular robotic character is meant as illustrative only and should be appreciated that the techniques described herein can be equally applicable to all types of robotic characters or designs.

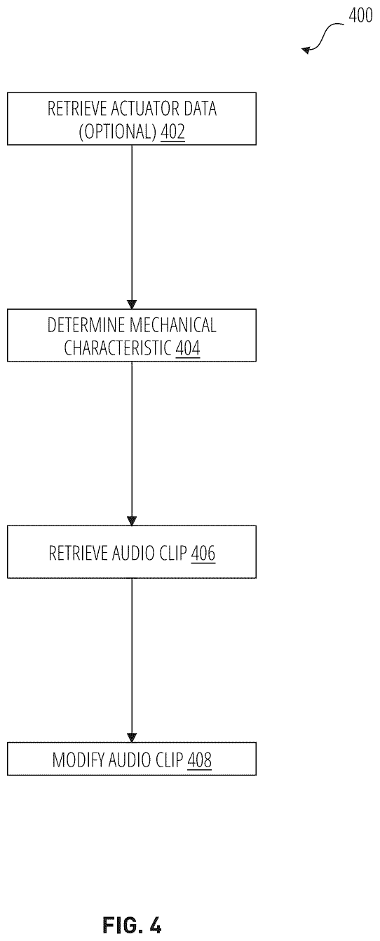

FIG. 4 illustrates an example method 400 for retrieving and modifying an audio clip, with the audio engine 114. According to some examples, optionally, the method 400 includes retrieving actuator data at operation 402. The audio engine may retrieve data from an actuator 120 of an active kinetic component 118. For example, the audio engine 114 may retrieve data by sampling a sensor coupled to the actuator 120 and configured to measure the position or movement of the actuator 120. The audio engine 114 determines a mechanical characteristic based on data retrieved from the actuator 120. For example, an encoder of the audio engine 114 determines a change in the position of the actuator 120 over time to estimate the velocity of the active kinetic component 118. The change in the position of the actuator may be caused by the actuator 120 or may be caused by a force external to the mechanical system 102. For example, a user 126 may push the active kinetic component 118, causing the active kinetic component 118 to move. In such examples, the encoder may likewise detect a change in position of the actuator 120 to estimate the velocity of the active kinetic component 118. In some examples, the audio engine 114 retrieves actuator data and determines the mechanical characteristic in real-time. The audio engine 114 may store the mechanical characteristic in memory (e.g., in mechanical characteristic data 208).

The method 400 also includes determining a mechanical characteristic at operation 404. The audio engine 114 determines mechanical characteristic data 208 of the mechanical system 102. The mechanical characteristic data 208 may reflect a movement and/or physical state of a passive kinetic component 116 or other passive component of the mechanical system 102 that is not powered by an actuator. For example, the mechanical characteristic data 208 may reflect the position of a lever that may be moved by a user 126. The audio engine 114 may retrieve data from a physical parameter sensor 122 to determine the mechanical characteristic. For example, the audio engine 114 may retrieve data from a Hall effect sensor mounted to a passive kinetic component 116 and estimate the movement and velocity of the passive kinetic component 116 based on the data from the Hall effect sensor. In another example, the audio engine 114 may determine the location of the mechanical system 102 based on positional data retrieved from a GPS sensor. The audio engine 114 may determine the mechanical characteristic in real-time. The audio engine 114 may store the mechanical characteristic in memory (e.g., in mechanical characteristic data 208).

In some instances, the method utilizes direct and/or indirect methods to determine the mechanical characteristics. For example, the method may include directly sampling or retrieving movement data for an actuator and use that information to determine a movement characteristic for the direct joint or a joint coupled indirectly to the actuator. Alternatively or additionally, the method may include indirectly detecting movement, such as through an encoder or sensor that identifies motion (rather than detecting a signal causing motion via a motor or the like). In other instances, the system may utilize both a direct signal, such as a voltage value provided to a motor for an active kinetic actuator and a detected change through a sensor configured to detect a different position of the active kinetic actuator. In various embodiments, the type of detection used may be configured to have a lowest possible latency to ensure that the audio playback is temporal with the movement.

The method 400 also includes retrieving an audio clip based on the mechanical characteristic data 208 at operation 406. For example, where the mechanical characteristic data 208 indicates a positive acceleration of an arm component of the mechanical system 102, and the arm component is configured to appear metallic, the audio engine 114 may retrieve an audio clip reflecting a movement of a metallic component, such as audio of metallic gears turning. As another example, where the mechanical characteristic data 208 indicates that the arm component is subject to a torque force, the audio engine 114 may retrieve an audio clip reflecting torque applied to a metal component, such as audio of straining metal associated with torque applied to a metal component.

In some examples, the audio engine 114 may retrieve an audio clip based on the appearance of the mechanical system 102 rather than the composition of the mechanical system 102. For example, where the arm component appears metallic, the audio engine 114 may retrieve an audio clip reflecting metallic sounds even if the actual composition of the arm component is plastic. The audio engine 114 may retrieve the audio clip from a data store 108 or user device 106 (e.g., via the network 104). For example, the audio engine 114 may retrieve the audio clip from an online server storing sound effect files. The audio engine 114 may retrieve the audio clip based on the audio metadata of the audio clip. For example, the audio engine 114 may query for an audio clip with a specific title or identifier and retrieve the resulting audio clip. The audio engine 114 may store the audio clip in memory (e.g., in audio data 206).

In some examples, the audio clip may be pre-loaded or stored in a memory component of the mechanical system 102 (e.g., stored in audio data 206). For example, the mechanical system 102 may store audio clips of sound effects that correspond to common movements of the mechanical system 102 and are frequently played by the audio output device 124. In such examples, the audio engine may not retrieve the audio clip from a storage source external to the mechanical system 102 and may instead select the pre-loaded audio clip from the memory component of the mechanical system 102.

The method 400 also includes modifying an audio clip at operation 408 based on the mechanical characteristic data 208. The audio engine 114 may modify the audio clip according to the audio modification instructions 210 as described with respect to FIG. 2. For example, the audio engine 114 may modify the audio clip by changing the speed, frequency (i.e., pitch), amplitude (i.e., volume), and/or duration of the audio clip. The audio engine 114 may also modify the audio clip by mixing in and/or layering on an additional audio clip. The audio engine 114 may modify the audio clip to correspond with a mechanical characteristic of the mechanical system 102. For example, where the mechanical characteristic data 208 indicates that an arm component of the mechanical system 102 is moving at a slow speed, the audio engine 114 may modify the audio clip corresponding to the movement of the arm component by reducing the tempo or speed of the audio to match the speed of the arm component movement. Where the mechanical characteristic data 208 indicates that the arm component is accelerating, the audio engine 114 may modify the audio clip to gradually increase in speed at the same rate as the positive acceleration of the arm component. The audio engine 114 may modify the audio clip to correspond in real-time with the changes to the mechanical characteristics of the mechanical system 102.

In some examples, the audio engine 114 may modify an audio clip based on audio thresholds. For example, the audio engine 114 may determine a maximum volume threshold and pitch threshold. Where the audio engine 114 modifies an audio clip to incrementally increase in volume and pitch upon a positive acceleration of a component of a robotic character, the audio engine 114 may limit the modification of the audio clip such that the volume and pitch of the audio clip never exceed the volume threshold and pitch threshold despite a continuous positive acceleration of the component. Likewise, the audio engine 114 may determine a minimum volume threshold and pitch threshold limiting the minimum volume and pitch of a modification of the audio clip.

It should be noted that although the method 400 discuses examples of both selecting and modifying an audio clip, in some instances the method 400 may do one or the other. For example, a set audio clip may be determined within the robotic character and the audio clip is modified based on the mechanical characteristic. As another example, in some instances, the selection of the audio clip may be between a first “fast” audio clip that corresponds to a fast motion and a second “slow” audio clip that corresponds to a slow motion. In this manner, the audio clip itself may not be modified to generate a different playback speed or frequency, but separate audio clips may be used to generate the effect. In any of the embodiments, however, the audio clip playback is used to create an acoustic effect correlated with the robotic mechanical characteristics.

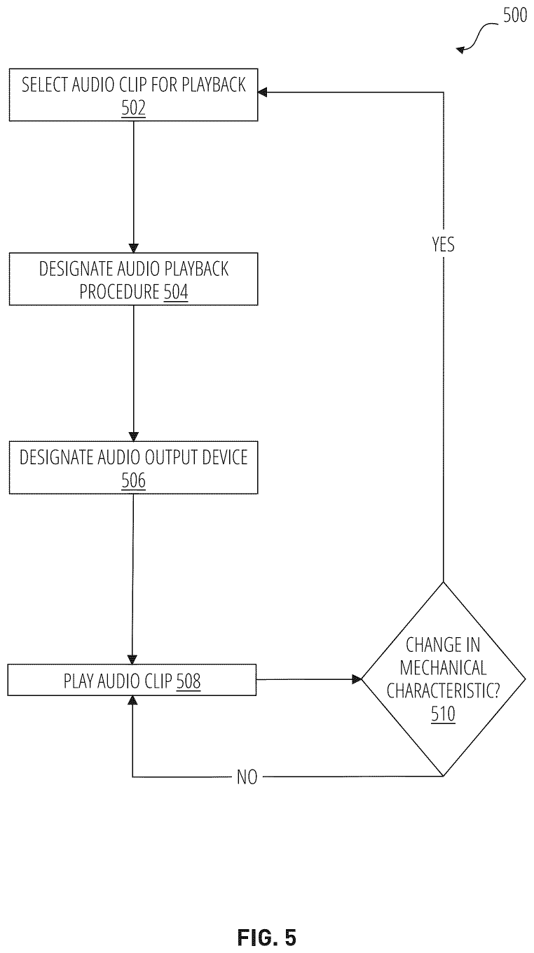

FIG. 5 illustrates an example method 500 for playing an audio clip, with the audio engine 114. According to some examples, the method 500 includes selecting an audio clip for playback based on mechanical characteristic data 208 at operation 502. The audio engine 114 may select the audio clip to correspond with a mechanical characteristic of the mechanical system 102. In some examples the audio clip may be retrieved and modified as described with respect to method 400. For example, where a leg component of a robotic character is moving in a walking motion, the audio engine 114 may select an audio clip including sound effects of walking and footsteps.

In some examples the audio engine 114 may select an audio clip reflecting a realistic sound of the mechanical characteristic. In other examples, the audio engine 114 may select an audio clip reflecting a fantastical or exaggerated sound of the mechanical characteristic. For example, the audio engine 114 may select an audio clip of a cartoonish bouncing sound effect in response to a mechanical characteristic indicating a jumping motion of the robotic character.

In some examples, the audio engine 114 may select an audio clip for playback based on a physical characteristic of the mechanical system 102, including a material of the mechanical system 102, a construction of the mechanical system 102 and/or a purpose of the mechanical system 102. For example, the audio engine 114 may select an audio clip with metallic sound effects where the mechanical system 102 is composed with metallic materials. The audio engine 114 may select an audio clip with sound effects commonly associated with robots where the mechanical system 102 is a robotic character. Where the mechanical system 102 is designed to portray a specific character or object, such as a specific device from a movie, the audio engine 114 may select an audio clip including audio associated with the specific device.

The method 500 also includes designating an audio playback procedure for an audio clip (e.g., the audio clip selected at operation 502) at operation 504. In some examples, the audio engine 114 may designate the audio playback procedure to play the audio clip in a loop such that the audio continuously loops. The audio engine 114 may designate playing the audio clip in a loop where the mechanical characteristic data 208 indicates a continuous or repetitive motion of a component of the mechanical system 102. For example, where a robotic character performs a repetitive clapping hand motion, the audio engine 114 may designate playing an audio clip of a clap sound effect in a loop such that the looping clap sound effects correspond to the repetitive clapping hand motion. In other examples, the audio engine 114 may designate the audio playback procedure to play the audio clip upon a trigger condition, such as the occurrence of a specific mechanical characteristic. For example, the audio engine 114 may designate playing an audio clip of a falling sound effect upon the robotic character reaching an acceleration corresponding to free fall. In another example, the audio engine 114 may designate playing an audio clip of a contact noise upon the robotic character contacting or interacting with another object.

In some examples, the audio engine 114 may designate an audio playback procedure for the audio clip based on characteristics of the audio clip. For example, an audio clip may include repeating audio. In such examples, the audio engine 114 may designate an audio playback procedure to play the audio clip in a loop to correspond with the repeating audio of the audio clip.

The method 500 also includes designating an audio output device 124 for an audio clip (e.g., the audio clip selected at operation 502) for the playback of the audio clip at operation 506. The audio engine 114 may designate an audio output device 124 based on a proximity of the audio output device 124 to a component of the mechanical system 102 corresponding to the audio clip, such that the designated audio output device 124 is the audio output device 124 closest to the expected source of the audio. For example, where a robotic character is performing a clapping hand motion, and a corresponding audio clip includes clapping sound effects, the audio engine 114 may designate an audio output device 124 near the hand component of the robotic character for the playback of the audio clip.

In some examples, where the mechanical system 102 includes multiple audio output devices 124, the audio engine 114 may designate all audio output devices 124 for playback of an audio clip, but modify the volume of the playback such that the volume of the playback is louder at an audio output device 124 closer in proximity to the expected source of the audio and quieter at an audio output device 124 further in proximity to the expected source of the audio. In some examples where there are multiple audio clips, the audio engine 114 may designate a single audio output device 124 for the simultaneous playback of multiple audio clips and modify the volume of each audio clip based on the proximity to the expected source of the audio. For example, an audio output device 124 near a hand component may be designated for the playback of a first audio clip corresponding to a motion of the hand component and a second audio clip corresponding to a motion of a foot component. The audio engine 114 may modify the first audio clip to be louder than the second audio clip since the audio output device 124 is closer to the hand component and further from the foot component.

The method 500 also includes playing an audio clip (e.g., the audio clip selected at operation 502) at operation 508. The audio engine 114 may play the audio clip from the audio output device 124 designated at operation 506 with the audio playback procedure designated at operation 504. The processing latency for all operations of method 500 may be sufficiently low such that the playback of the audio clip coincides in real-time with the corresponding mechanical characteristic of the mechanical system 102. For example, an audio output device 124 may play a clapping sound effect coinciding in real-time with a clapping hand motion of a robotic character such that the clapping sound effect is in synchrony with the clapping hand motion.

The method 500 also includes sampling the mechanical system 102 to determine a change in a mechanical characteristic at decision block 510. The audio engine 114 may sample an actuator 120 and/or a physical parameter sensor 122 to determine a change in a mechanical characteristic. Where the audio engine 114 determines that a mechanical characteristic corresponding to a first audio clip played at operation 508 has changed, the audio engine 114 may select a second audio clip corresponding to the change in the mechanical characteristic as described with respect to operation 502. For example, where the audio engine 114 determines that movement of a robotic character has changed from a walking motion to a running motion, the audio engine 114 may change the selected audio clip for playback from a walking sound effect to a running sound effect. Where the audio engine 114 determines that there is no change in a mechanical characteristic corresponding to a first audio clip played at operation 508, the audio engine 114 may continue to play the first audio clip as described with respect to operation 508. For example, where the robotic character continues to walk at a constant pace, the audio engine 114 may continue to play a walking sound effect from an audio output device 124.

The audio engine 114 may sample the mechanical system 102 to determine a change in a mechanical characteristic at a rate with sufficiently low latency such that selecting and playing a new audio clip coincides in real-time with the change in the mechanical characteristic. For example, where the movement of the robotic character changes from a walking motion to a running motion, the selection and playback of the running sound effect occurs in synchrony with the change to the running motion. The audio engine 114 may sample the mechanical system 102 at different rates based on the mechanical characteristic data 208. For example, where a first movement pattern of the mechanical system 102 includes frequent changes in velocity or acceleration and a second movement pattern of the mechanical system 102 includes stable motion without frequent changes in velocity or acceleration, the audio engine 114 may sample the mechanical system 102 at a higher rate during the first movement pattern than during the second movement pattern. In this manner, the sampling rate may correspond to an expected frequency of change in mechanical characteristic.

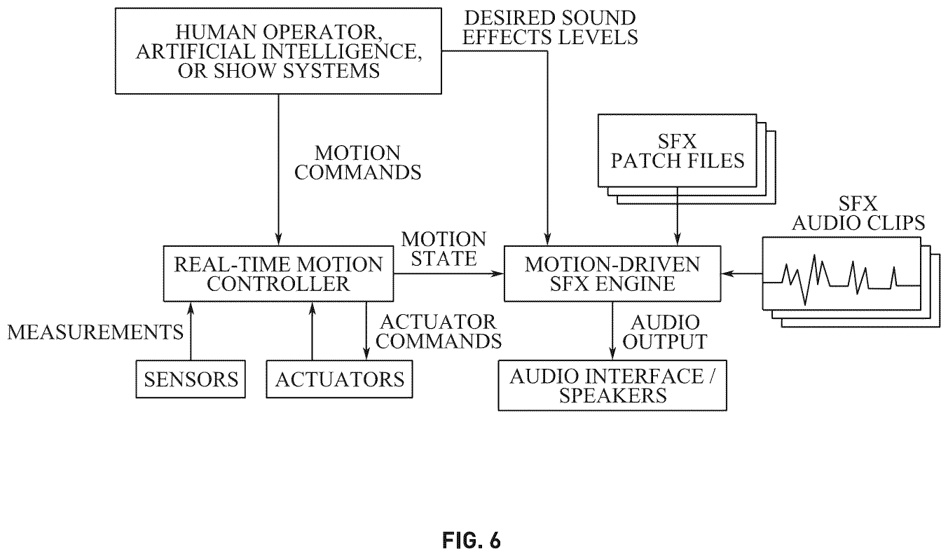

FIG. 6 illustrates an example implementation flow diagram for generating motion-driven audio, such as utilizing method 400 and method 500. As shown, in FIG. 6, the SFX engine runs on a robot's control computer, in parallel with a real-time motion controller (e.g., a controller system 112) that determines the robot's movements. In this example, the engine generates an audio output signal on-the fly using a “motion state” signal produced by the controller (e.g., as determined based on a mechanical detector or sensor). The motion state may include estimated and/or commanded positions, velocities, accelerations, and/or torques for the robot's actuators or joints, as well as additional estimated states computed from on-board sensors such as inertial measurement units (IMUs) such as the root position/velocity of the robot relative to the world. In one example, the audio engine can run as a real-time process on the robot's onboard computer and in parallel with the robot's controller processor. This enables the audio engine to generate real-time audio using the estimated robot state produced by the onboard controller. The audio engine may then provide an audio output (which may be selected based on the movement) to the onboard speakers or other acoustic output, generating an effect having the sound produced by the movement or state of the robot.

In this example, the SFX system allows an artist or other creator to generate one or more SFX “patches” (e.g., audio clips) that define various mechanical sounds accompanying a robot's motion. The SFX patches or audio clips may include sampled or synthesized audio content, as well as parameters defining how the audio content is modulated and triggered as a function of the time-varying motion state. Patches can be authored off-line or on-line and are stored as files that can be deployed to the robot and loaded by the proposed SFX engine. The audio output of the proposed engine is fed to an audio interface with one or more on-board speakers, creating the effect that the sound is a product of the mechanical robot.

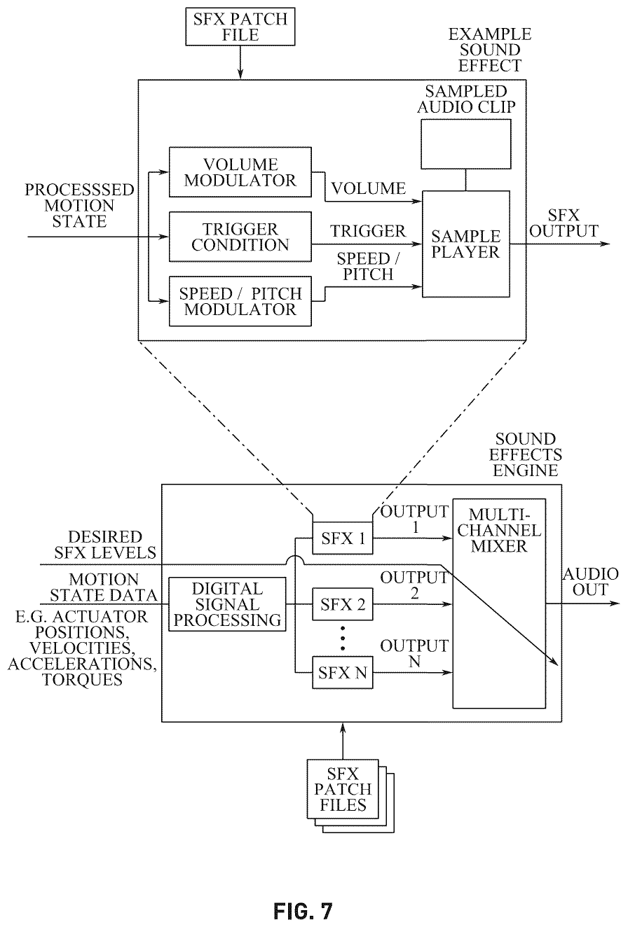

FIG. 7 illustrates an example implementation block diagram of an audio engine 114 as described with respect to FIG. 2. In some examples, the audio engine 114 may be an SFX engine configured to generate motion-driven SFX. As shown in FIG. 7, the audio engine 114 may determine a mechanical characteristic (e.g., motion state data) of a mechanical system 102 in real-time. For example, the audio engine 114 may apply digital filters, signal conditioning, and estimating the derivative signals (e.g., velocities and accelerations) to motion state data of the mechanical system 102 to process the motion state data. The audio engine may select, modify, and play an audio clip based on the mechanical characteristic. For example, the processed motion state is passed as an input to multiple digital effects. Each effect modulates and triggers audio content based on various measurements of the motion state data according to a corresponding effects patch. The effects outputs are then combined using a multi-channel mixer based on the desired SFX levels provided by an Al planner, human operator, or show systems software.

Consider the example sound effect, SFX 1, illustrated in FIG. 7. With reference to FIG. 7, a motion-driven modification of an audio clip is shown. For example, SFX 1 may be a sample-based sound effect with motion-based triggering, speed, and volume. In one embodiment, the audio clip could be a looped sound file, such as a recording of a gear box at a fixed speed, or a transient sound clip, such as a single gear tooth clicking, that is triggered based on the time-varying motion state. Mechanical actuators are typically equipped with transmissions that produce mechanical sounds that vary with speed and load. The audio engine 114 is capable of emulating these sounds by modulating the playback characteristics (trigger time, volume, and speed) of an audio clip based on a mechanical characteristic of the actuator 120, such as the computed joint speed or power. For example, a looped gear box sample can be made to create an effect that emulates a gearbox varying in speed by varying the playback speed and volume proportionally to the speed of the robot's joint. Thus, it is possible to “retarget” the original sound to match the physical motion of the robot.

The audio engine 114 may modify the audio clip according to audio modification instructions 210 to include multiple layers of looped audio clips and a set of modulation parameters that define how these clips are processed based on a modulation source, i.e., a function of the measured joint states. The audio engine 114 may designate the playback for the audio according to audio playback instructions 212. For example, the audio engine 114 can play the audio clip from an audio output device 124 near an individual joint, emulating the mechanical sound of a single actuator, or the audio engine 114 can play the audio clip from multiple audio output devices 124 as a combined sound source that is modulated by multiple joint states. This latter case is useful for emulating the sound of centralized mechanical power sources, such as a hydraulic pump (imagine the sound an excavator arm makes as it picks up a load). In this case, the modulation source for a pump-like sound clip may be the total measured mechanical power of all the actuators combined.

It may also be useful to change the generated sound on the fly, in response to certain events, motions, or story-driven content. The audio engine 114 may select an audio clip and modify audio characteristics of the audio clip in real-time based on a mechanical characteristic of the mechanical system 102 during the operation of the mechanical system 102. For example, the audio engine 114 may select and play gear noises while a bipedal robot walks, then select and play a droning noise that is modulated by the robot's neck actuators during a scanning motion. The audio engine 114 may update the gear effect mid-walking to produce a grinding sound if a storyline involved the robot acting as if it was damaged.

In various implementations, the audio engine 114 may be configured to generate realistic or thematic sounds based on actual output or movements by a robotic character, where the movement of the robotic character is not predetermined or predicted ahead of time. This enables a more immersive and realistic experience for a user 126 interacting with or viewing the robotic characters.

FIG. 8 illustrates a block diagram of an example computer system suitable for use in embodiments disclosed herein in accordance with an embodiment of the disclosure. For example, the mechanical system 102 may include or utilize one or several computing systems 800, and the processor 202 and memory 204 may be located at one or several computing systems 800. In various embodiments, the controller system 112 and audio engine 114 are implemented by a computing system 800. In various implementations, the user device 106 and/or additional user devices may be implemented using any number of computing devices including, but not limited to a computer, laptop, tablet, mobile phone, smart phone, wearable device (e.g., AR/VR headset, smartwatch, smart glasses, or the like), smart speaker, vehicle (e.g., automobile), or appliance.

This disclosure contemplates any suitable number of computing systems 800. For example, the computing system 800 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 800 may include one or more computing systems; be unitary or distributed; span multiple locations; span multiple machines; span multiple data centers; or reside in a cloud, which may include one or more cloud components in one or more networks. The computing system 800 may include one or more processors 802, an input/output (I/O) 806, one or more external devices 808, one or more memory components 810, and a network interface 812. Each of the various components may be in communication with one another through one or more buses or communication networks, such as wired or wireless networks.

In some embodiments, various components of the computing system 800 may communicate with one another through the network 104. For example, in some embodiments, the computing system 800 may be implemented as a serverless service, where computing resources for various components of the computing system 800 may be located across various computing environments (e.g., cloud platforms) and may be reallocated dynamically and/or automatically according to, for example resource usage of the computing system 800. In various implementations, the computing system 800 may be implemented using organizational processing constructs such as functions implemented by worker elements allocated with compute resources, containers, virtual machines, and the like.

The processor 802 may be any type of electronic device capable of processing, receiving, and/or transmitting instructions. For example, the processor 802 may be a central processing unit, graphics processing unit, microprocessor, processor, or microcontroller. Additionally, it should be noted that some components of the computing system 800 may be controlled by a first processor and other components may be controlled by a second processor, where the first and second processors may or may not be in communication with each other. The controller system 112, audio engine 114, and user device 106 may perform operations by executing executable instructions (e.g., software) using the processor 802. The processor 802 may be used to implement the processor 202 shown in FIG. 2.

The i/o interface 806 allows a user to enter data in to computing system 800, as well as provides an input/output for the computing system 800 to communicate with other devices or services. The i/o interface 806 can include one or more input buttons, touch pads, and so on.

The external devices 808 are one or more devices that can be used to provide various inputs to the computing system 800, e.g., mouse, microphone, keyboard, trackpad, or the like. The external devices 808 may be local or remote and may vary as desired. In some examples, the external devices 808 may also include one or more additional sensors.

The memory components 810 are used by the computing system 800 to store instructions for the processor 802 and may be implemented as a data store and the like. The memory components 810 may be, for example, magneto-optical storage, read-only memory, random access memory, erasable programmable memory, flash memory, or a combination of one or more types of memory components. The memory components 810 may be used to implement the memory 204 shown in FIG. 2. The memory 204 may include various instructions for various functions of the audio engine 114 which, when executed by the processor 202, perform various functions of the audio engine 114. The memory 204 may further store data and/or instructions for retrieving data used by the audio engine 114. Similar to the processor 202, the memory 204 utilized by the audio engine 114 may be distributed across various physical computing devices. In some examples, the memory 204 may access instructions and/or data from other devices or locations, and such instructions and/or data may be read into memory 204 to implement the audio engine 114.

The network interface 812 provides communication to and from the computing system 800 to other devices. The network interface 812 includes one or more communication protocols, such as, but not limited to WI-FI®, Ethernet, BLUETOOTH®, and so on. The network interface 812 may also include one or more hardwired components, such as a Universal Serial Bus (USB) cable, or the like. The configuration of the network interface 812 depends on the types of communication desired and may be modified to communicate via WI-FI®, BLUETOOTH®, and so on.

The network interface 812 may interface with the network 104. The network 104 may be implemented using one or more wired and/or wireless systems and protocols for communications between computing devices. In various embodiments, the network 104 or various portions of the network 104 may be implemented using the internet, a local area network, a wide area network, and/or other networks. In addition to traditional data networking protocols, in some embodiments, data may be communicated according to protocols and/or standards including near field communication, Bluetooth®, Wi-Fi, cellular connections, or the like.

The display 804 provides a visual output for the computing devices and may be varied as needed based on the device. The display 804 may be configured to provide visual feedback to the user and may include a liquid crystal display screen, light emitting diode screen, plasma screen, or the like. In some examples, the display 804 may be configured to act as an input element for the user through touch feedback or the like.

The components in FIG. 8 are exemplary only. In various examples, the computing system 800 may include additional components and/or functionality not shown in FIG. 8.

Accordingly, the mechanical system 102 described herein addresses particular challenges and needs presented by audio playback accompanying mechanical systems. For example, mechanical systems often accompany the movement of mechanical systems with predetermined sound effects that may not correspond to the movement of the mechanical system and may hinder the immersive experience of a user interacting with the mechanical system. The audio engine 114 of the mechanical system 102 described herein modifies and plays audio corresponding with mechanical characteristics of the mechanical system 102, such as the movement of the mechanical system 102 or interaction of the mechanical system 102 with external factors. Thus, the motion-driven audio increases the immersive experience for users interacting with the mechanical system 102 as the sound played by the mechanical system 102 matches the movement and physical state of the mechanical system 102.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The description of certain embodiments included herein is merely exemplary in nature and is in no way intended to limit the scope of the disclosure or its applications or uses. In the included detailed description of embodiments of the present systems and methods, reference is made to the accompanying figures which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

Although the methods described herein (e.g., method 400 and method 500) depict a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the figures and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and figures are to be regarded in an illustrative manner and are not intended to limit the scope of the appended claims.

What is claimed is:

1. A computer implemented method for generating a motion-driven sound effect comprising:
determining, via a processor, a mechanical characteristic of a mechanical system;
modifying, via the processor, an audio clip based on the mechanical characteristic; and
outputting, via the processor, the audio clip based on the mechanical characteristic.

2. The method of claim 1, wherein the mechanical characteristic comprises at least one of a position, velocity, acceleration, or torque of a component of the mechanical system.

3. The method of claim 2, wherein the velocity, acceleration, or torque of the component is caused by a force applied to the component external to the mechanical system.

4. The method of claim 1, wherein the mechanical characteristic comprises at least one of an ambient temperature or weather condition of the mechanical system.

5. The method of claim 1, wherein determining the mechanical characteristic of the mechanical system comprises:
measuring a physical parameter of the mechanical system with a physical parameter sensor; and
determining the mechanical characteristic based on the physical parameter.

6. The method of claim 1, wherein determining the mechanical characteristic of the mechanical system comprises estimating a velocity of the mechanical system based on a change in position of an actuator of the mechanical system.

7. The method of claim 1, wherein modifying the audio clip based on the mechanical characteristic comprises selecting the audio clip based on the mechanical characteristic.

8. The method of claim 7, wherein selecting an audio clip comprises selecting an audio clip based on a physical characteristic of the mechanical system; the physical characteristic comprising at least one of a material of the mechanical system, a construction of the mechanical system, or a purpose of the mechanical system.

9. The method of claim 1, wherein modifying the audio clip based on the mechanical characteristic comprises modifying the frequency and amplitude of the audio clip to replicate a physical sound associated with a velocity and acceleration of a component of the mechanical system.

10. The method of claim 1, wherein modifying the audio clip based on the mechanical characteristic comprises modifying the frequency and amplitude of the audio clip to replicate a physical sound associated with an external force or torque applied to a component of the mechanical system.

11. The method of claim 1, wherein modifying the audio clip based on the mechanical characteristic comprises modifying a frequency of the audio clip within a minimum frequency threshold and a maximum frequency threshold.

12. The method of claim 1, wherein modifying the audio clip based on the mechanical characteristic comprises modifying an amplitude of the audio clip within a minimum amplitude threshold and a maximum amplitude threshold.

13. The method of claim 1, wherein outputting the audio clip based on the mechanical characteristic comprises outputting the audio clip from a designated audio output device mounted to the mechanical system.

14. The method of claim 13, wherein the designated audio output device is one of a plurality of audio output devices, wherein the designated audio output device is the audio output device located closest in proximity to the source of the mechanical characteristic.

15. The method of claim 1, wherein outputting the audio clip based on the mechanical characteristic comprises outputting a loop of the audio clip coinciding in real-time with the mechanical characteristic.

16. The method of claim 1, wherein outputting the audio clip based on the mechanical characteristic comprises outputting the audio clip upon the occurrence of a trigger condition, coinciding in real-time with the trigger condition.

17. A mechanical system for generating motion-driven audio, comprising:
an audio output device;
a physical parameter sensor;
a local storage system; and
a processor configured by instructions to perform operations comprising:
determining a mechanical characteristic of the mechanical system;
modifying an audio clip based on the mechanical characteristic; and
outputting the audio clip based on the mechanical characteristic to the audio output device.

18. The mechanical system of claim 17, wherein modifying the audio clip based on the mechanical characteristic comprises modifying the frequency and amplitude of the audio clip to replicate a physical sound associated with a velocity and acceleration of a component of the mechanical system.

19. The mechanical system of claim 17, wherein modifying the audio clip based on the mechanical characteristic comprises modifying the frequency and amplitude of the audio clip to replicate a physical sound associated with an external force or torque applied to a component of the mechanical system.

20. The mechanical system of claim 17, wherein outputting the audio clip based on the mechanical characteristic comprises outputting the audio clip coinciding in real-time with the mechanical characteristic.
